(19) United States
(12) Patent Application Publication
(10) Pub. No.: US 2003/0142342 A1
(43) Pub. Date: Jul. 31, 2003

(54) Printing system with notification function

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O. Box 272400, Fort Collins, CA, 80527-2400, US

(21) Appl. No.: 10/059,083

(22) Filed: Jan. 28, 2002

(51) Int. Cl. B41B 1/00

(52) U.S. Cl. 358/1.15; 709/206

(57) ABSTRACT

A printing system that includes a computer and a printer is described. A user can interact with the computer to submit a print job that describes a document to the printer. The user can also request that a message be automatically transmitted when certain conditions exist, the conditions may include the document meets at least one criterion and the printer encounters an event while processing the print job.

### BACKGROUND

A user of a printer may wish to be notified when the printer encounters certain events while processing the user's print job. The user, for example, may wish to know if the printer encounters an event that prevents the printer from completely printing the job. An event of this type may be referred to herein as a “job failure”. A job failure may occur, for example, due to the depletion of a printer resource such as printing media, toner, ink, etc. A job failure may also occur for other reasons, such as a media jam or a mechanical failure.

Notifying the user when the printer encounters a particular event, however, can present a problem. The user, for example, may submit a job to a printer from one location (location “A”) and be at another location (location “B”) when the event occurs. In today's mobile society, location “B” might be any remote location (e.g., the user's home, a child's soccer game, an airport, etc.).

Even if a mechanism were available to notify the user at these various locations, however, whether or not a user would want to be notified may depend on his/her personal preferences.

Consider the following example. Suppose a user submits a job at his/her place of business. While the job is printing, the user then goes home. While the user is at home, the printer processing the job encounters a job failure. In this example, the user may or may not wish to be notified at home of the job failure. This may depend on how important it is to the user that the job successfully prints.

### SUMMARY

According to one embodiment (among others) the invention provides a method of transmitting a message. The method may include, for example, the step of transmitting a message to a remote destination when each of a set of pre-determined conditions exist. The pre-determined conditions may include, for example, that the document meets a pre-determined criterion and that the printer encounters an event of a pre-selected type while processing the print job.

### BRIEF DESCRIPTION OF THE DRAWINGS

FIG. 1 is a block diagram of a computing system illustrating, by way of example, an embodiment of the invention;

FIG. 2 is a flow chart illustrating a function of a computer in the system;

FIG. 3 is an abstract drawing for illustrating an example of the operation of the computer to perform the function;

FIG. 4 is a flow diagram illustrating how a user can create a personal job document;

FIG. 5 is a high level block diagram of a printer;

FIG. 6A-C is a flow chart illustrating how a user can make use of a printing service provided by the printer;

FIG. 7 illustrates an example of a Web page associated with the printing service;

FIG. 8A and FIG. 8B is a flow chart illustrating the operation of the computer under the direction of Web content provided by the printing service;

FIG. 9A is a flow chart illustrating one example of how the Web content may operate to generate a notification command;

FIG. 9B is a flow chart illustrating another example of how the Web content may operate to generate a notification command;

FIG. 10 is a flow chart illustrating the operation of the printer to perform a notification function; and

FIG. 11 is flow chart illustrating, by way of example, another embodiment of the invention.

### DESCRIPTION

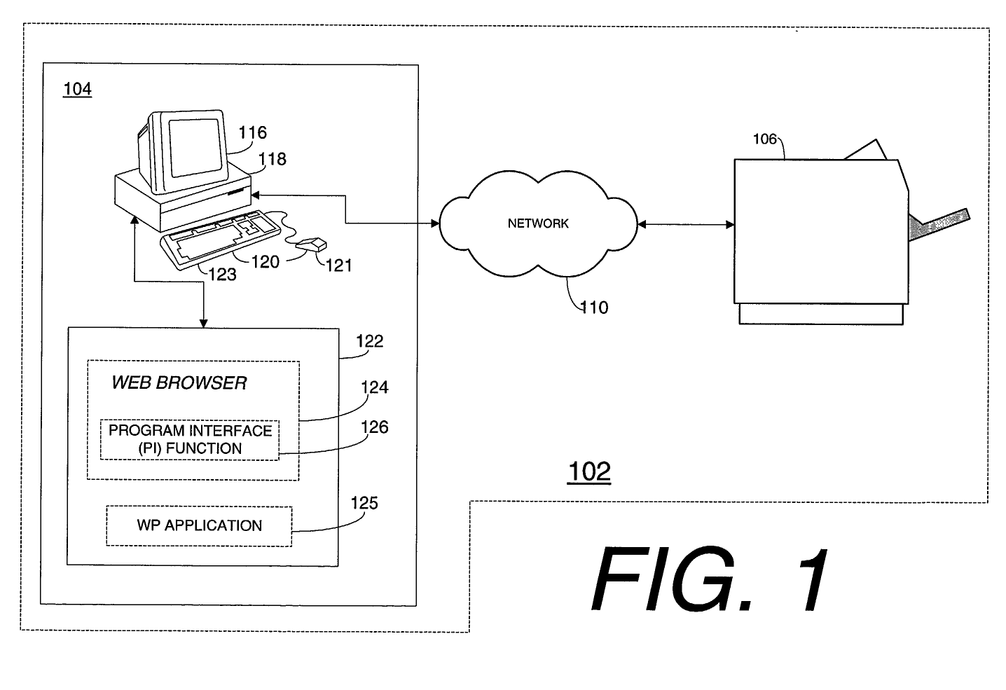

FIG. 1 depicts one embodiment of the invention in the form of a novel computing system 102. The computing system 102 includes a personal computer (PC) 104 and a printer 106 all connected to a network 110.

The printer 106 may represent any type of printer (e.g., an ink printer, laser printer, etc). The network 110 may represent, for example, an intranet, a series of networks, the Public Internet, a wireless network(s), etc., or some combination thereof.

In this embodiment, the PC 104 runs a local operating system. Each user of the PC 104 is assigned a user name and a unique user password. In order for a user to access the PC 104, the user first logs on. This involves the user establishing his/her online identity by inputting his/her assigned user name and assigned password. For ease of discussion, a user presently logged into the PC 104 may be referred to as the “active user”.

It is noted for the later discussion that, in the present embodiment, there exists a special classification of electronic documents. Documents that fall into this classification are referred to herein as “job documents”. Each job document is linked to a unique user's online identity (which in this example is the user's online identity that exists on the PC 104). A job document that is linked to a particular user's online identity may be referred to as being that user's “personal job document”. For ease of discussion, the active user's personal job document may be referred to herein as the “target job document”.

As shown in FIG. 1, the PC 104 includes a display monitor 116, a processing unit 118, user input devices 120 and a memory 122. The user input devices 120, in this embodiment, include a mouse 121 and a keyboard 123. The memory 122 may be internal or external to the PC 104.

Stored in the memory 122 is a Web Browser 124 and a word processing application 125. The processing unit 118 can retrieve and execute these two applications upon receiving an appropriate request from the user. The Web Browser 124 enables the PC 104 to run “Web content” and to function as a Web client in the system 102. As used herein, the phrase “Web content” refers to a program of computer readable instructions that may be executed by a Web Browser. Thus, for example, Web content may be a set of instructions written in any of the following languages (the following is a non-exhaustive list): HTML, Java, JavaScript, C-Sharp code, etc, or any combination thereof.

The Web browser 124 includes a program interface function (PI function) 126. Web content, running in the browser 124, can call the PI function 126 in order to access the “target job document”. As noted above, the “target job document” is the active user's personal job document.

It is noted that the call to invoke the PI function 126 is preferably device independent and is defined by a pre-determined standard. For ease of discussion, the call to invoke the PI function 126 may be referred to herein as the “get_job_doc” call. The standard that defines the call may be referred to herein as the “Web Imaging standard”.

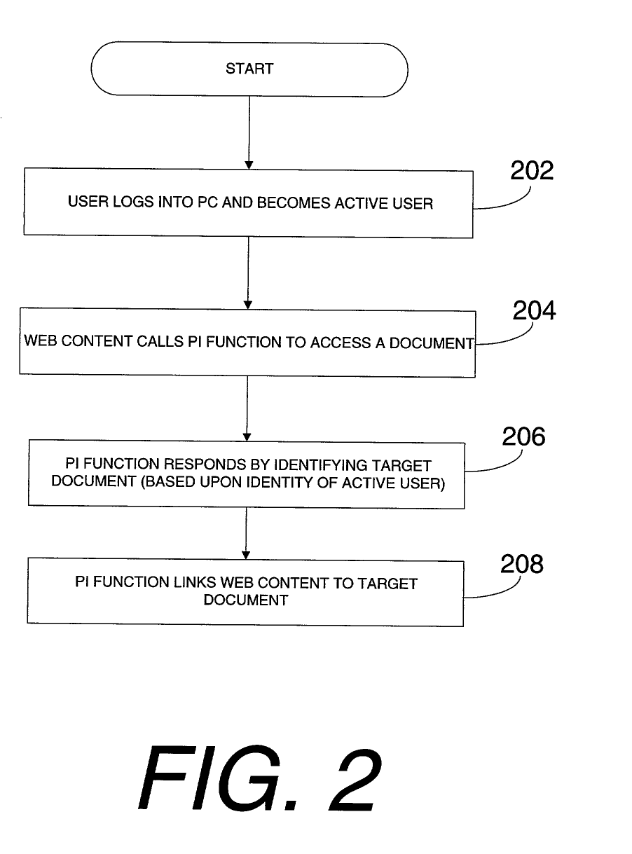

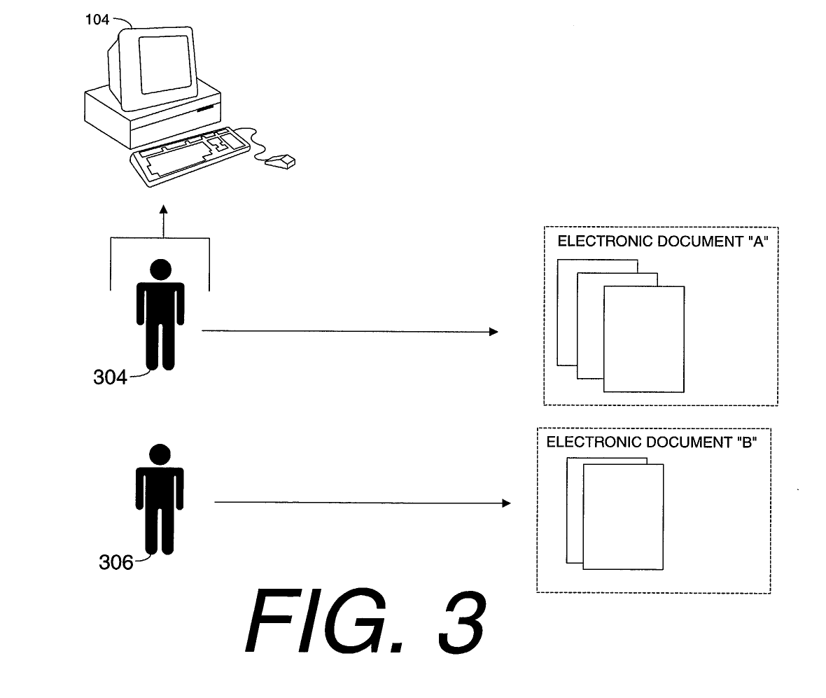

FIG. 2 is a flow chart illustrating generally and by way of example, the operation of the PI function 126. Turning now to FIG. 2, a user logs into the PC 104 (step 202). Next, it is assumed that WEB content running in the browser 124 calls the PI function 126 by issuing the “get_job_doc” call (step 204). In response, the PI function 126 identifies the document that qualifies to be the “target job document” (step 206). As noted above, the target job document is the active user's job document. Thus, the document that is identified at step 206 is based upon the online identity of the user who is presently logged in to the PC 104.

After the target job document is identified, the PI function 126 operates to provide the Web content with access to the target job document (Step 208).

To illustrate further the operation of the PI function 126, consider the following example that is depicted in FIG. 3. Assume there are two users of the PC 104: a first user 304 and a second user 306. The first user 304 has designated a first electronic document, “document A”, to be his/her personal job document. The second user 306 has designated a second electronic document, “document B”, to be his/her personal job document.

Under these conditions, when the first user 304 is the active user (i.e., when the first user 304 is presently logged into the PC 104) document “A” qualifies to be the “target job document”. Thus, when the first user 304 is the active user, the PI function 126 will operate to perform step 206 by identifying document “A” and will perform step 208 by providing the Web content (that issues the “get_job_doc” call) with access to document “A”.

When, however, the second user 306 is the active user, document “B” qualifies to be the “target job document”. Thus, when the second user 306 is the active user, the PI function 126 will operate to perform step 206 by identifying document “B” and will perform step 208 by providing the WEB content (that issues the “get_job_doc” call) with access to document “B”.

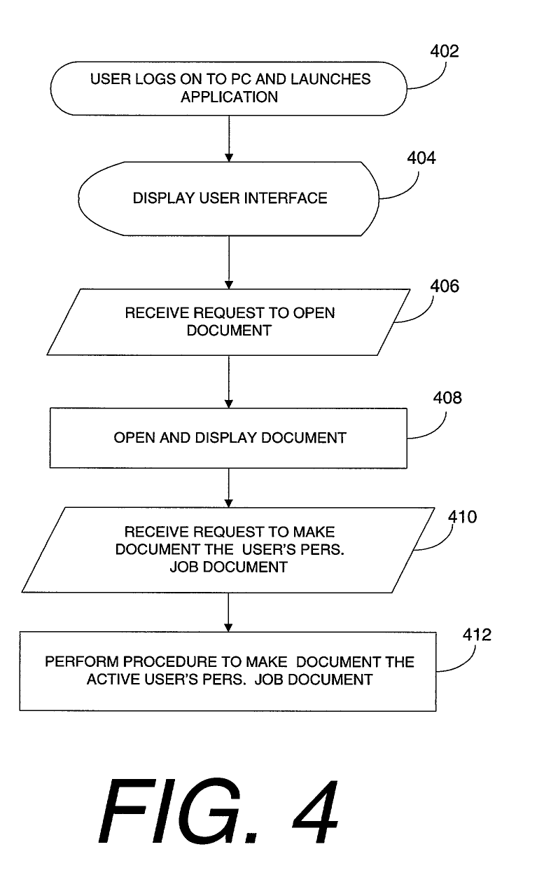

It is noted that one way a user of the PC 104 can make a “personal job document” is by use of the word processing application 125. FIG. 4 is a flow chart illustrating, by way of example, how a user can make use of the word processing application 125 to make a “personal job document”.

Referring now to FIG. 4, a user logs on to the PC 104 and launches the application 125 (Step 402). Upon being launched, the application 125 operates to display an initial graphical user interface (application GUI) (step 404). The application GUI provides various menus and options. A user can interact with the application GUI to create a new electronic document or to open an existing document. The application GUI further allows a user to input a request to make the document, presently open in the application 125, the user's personal job document.

At step 406, the user inputs a request to open a particular document. At step 408, the application 125 responds to the request by opening and displaying the document.

At step 410, the user inputs a request to make the open document his/her personal job document. In response to this user request, the application 125 follows a pre-determined procedure to make the document the user's personal job document (step 412). This procedure may involve placing an indicator in the active user's profile. The indicator indicates the location of the user's personal job document. The PI function 126 can later use this indicator in order to locate this document at step 206 when this document qualifies to be the target job document.

It is noted that certain aspects of the procedure followed in step 412 may be governed by the Web imaging standard mentioned above. This standard may specify, for example, that all job documents are to be filed in a portable document file (PDF) format. Thus, step 412 may involve converting the presently open document into a pre-determined file format.

Other aspects of the procedure followed in step 412, however, may be governed by user preferences (e.g., the storage location of the job document). It is contemplated, for example, that the user may be given the option to store his/her personal job document locally or in a remote location.

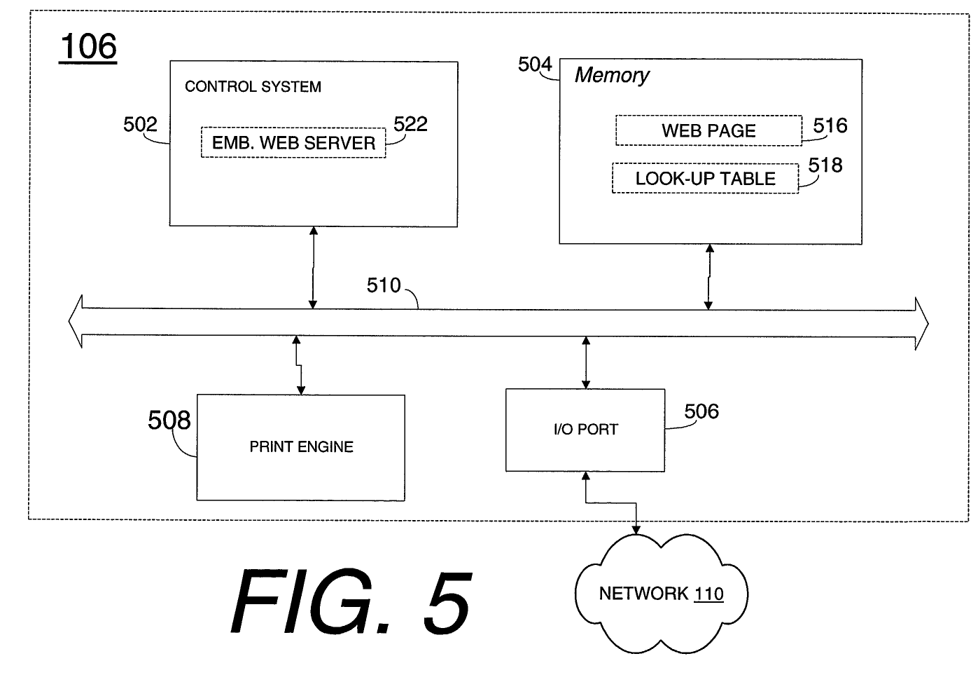

FIG. 5 is a high level block diagram of the printer 106. Turning to FIG. 5, the printer 106 includes a controller 502, a memory 504, an input/output port (I/O port) 506, and a print engine 508. All these components are connected via a local interface 510. The local interface 510 may represent any appropriate internal communication system.

The I/O port 506 links the printer 106 to the network 110. The print engine 508 includes the appropriate hardware components to print a document. The print engine 508 may represent any type of print engine capable of printing a document.

Stored in the memory 504 is a Web page 516 and a look-up table 518. The purpose of these two items is explained below.

The controller 502 controls the operation of the printer 106 and may include various hardware and firmware modules. It is noted for the later discussion that the controller 502 includes an embedded Web Server module 522. This module enables the printer 106 to function as a Web server in the computing system 102.

The Web Server module 522 enables the printer 106 to provide a Web based “printing service” to Web clients in the computing system 102. A Web client can access the printing service by transmitting an appropriate request to the printer 106. A user of the PC 104, for example, can use the printing service to print his/her personal job document. The printing service is explained below in greater detail.

Additionally, the printer 106 includes a notification function. If the notification function is enabled while a print job is being processed, the printer 106 operates to notify the job submitter when certain events (notification events) occur. In this embodiment, the printer 106 accomplishes this task by transmitting an e-mail message (notification message) to an address specified by the user. The notification message indicates that the event has occurred.

Whether or not the notification function of the printer 106 is enabled for a particular job is based upon user preferences. These preferences may be referred to herein as the user's “notification preferences”. As will be seen, the Web Page 516 provides the user with a GUI that enables the user to specify these preferences when the user first makes use of the printing service. The look-up table 518 is used to store the user's preferences so that they can later be retrieved (by use of a cookie) when the user again makes use of the service.

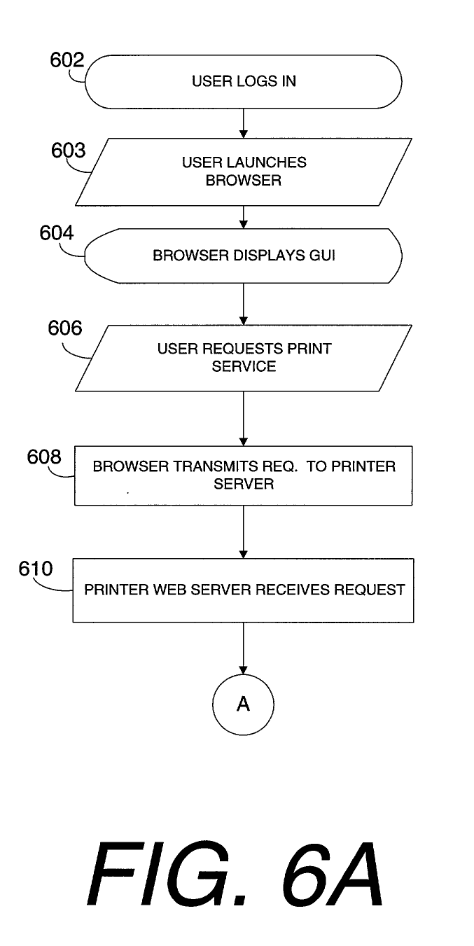

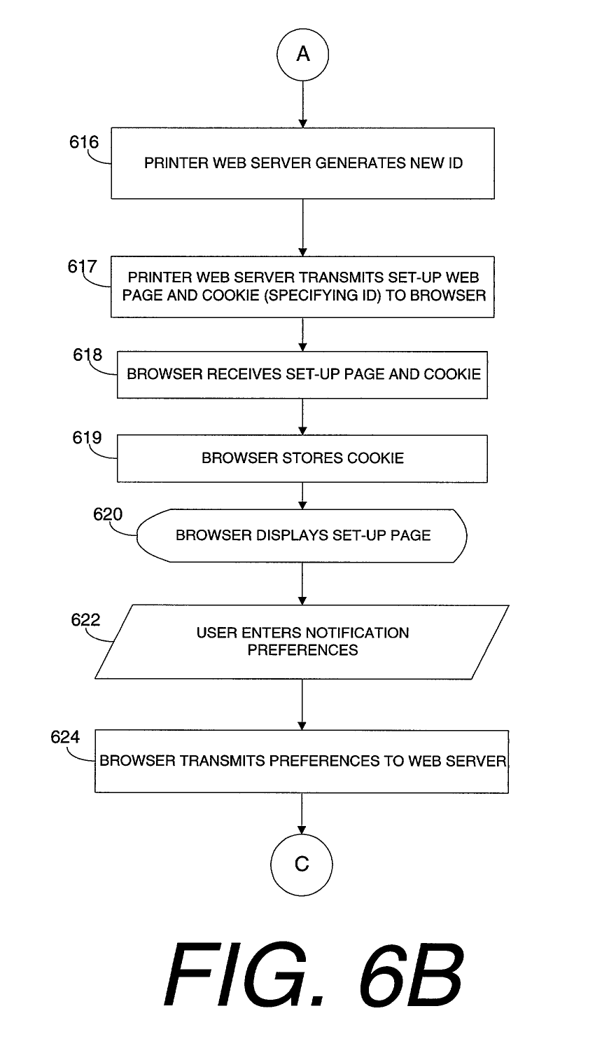

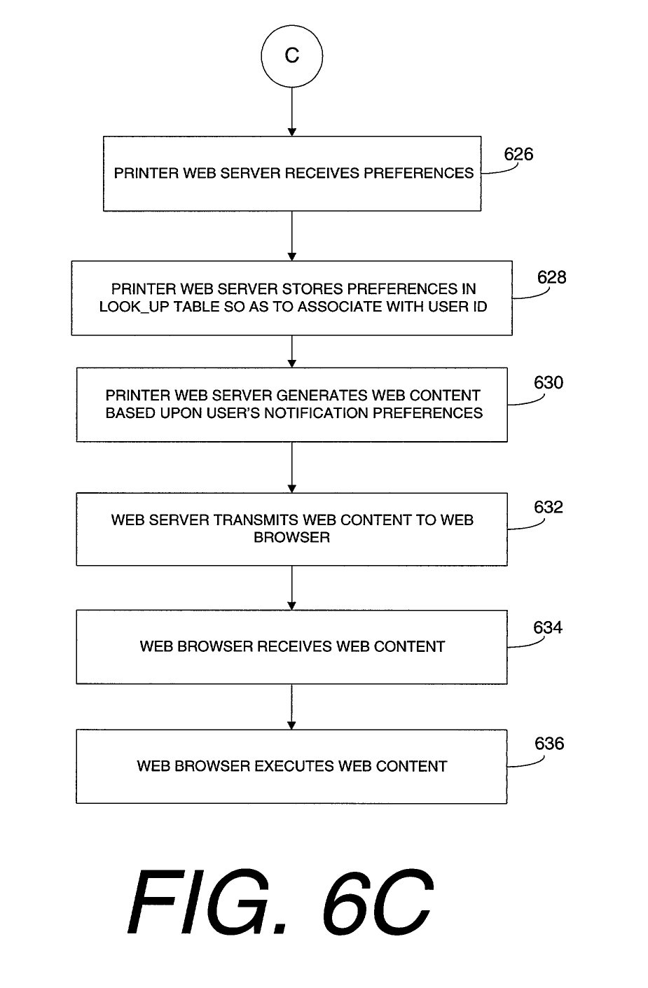

FIG. 6A-C is a flow chart illustrating, by way of example, how a user of the PC 104 can make use of the printing service to establish his/her notification preferences and to print his/her personal job document. In the following discussion, it will be assumed that this is the first time the user makes use of the printing service. As a result, the user has not yet established his/her notification preferences.

Turning to FIG. 6A, a user logs into the PC 104 (step 602). The user then interacts with the PC 104 to launch the Web browser 124 (step 603). Upon being launched, the Web Browser 124 displays a Graphical User Interface (Browser GUI) (step 604). The user interacts with the Browser GUI to request access to the printing service (step 606). This step may involve the user inputting a pre-determined URL assigned to the printing service.

In response to the user input received at step 606, the Web Browser 124 transmits (over the network 110) an appropriate request for the printing service to the printer 106 (step 608). The request (and the subsequent response to the request) may be transmitted using an HTTP protocol.

The printer 106 receives the request (step 610). In response to receiving the request, the printer 106 operates to generate a new “printing service” (PS) ID for the user (step 616). The Printer 106 then operates to transmit the Web Page 516 and a cookie to the Web Browser 124 (step 617). The cookie specifies the user's PS ID.

The Web Browser 124 receives the Web Page 516 and the cookie (step 618). The Web Browser 124 stores the cookie (step 619) appropriately and displays the Web Page 516 (step 620). As noted above, the Web Page 516 provides the user with a GUI that enables the user to specify his/her notification preferences.

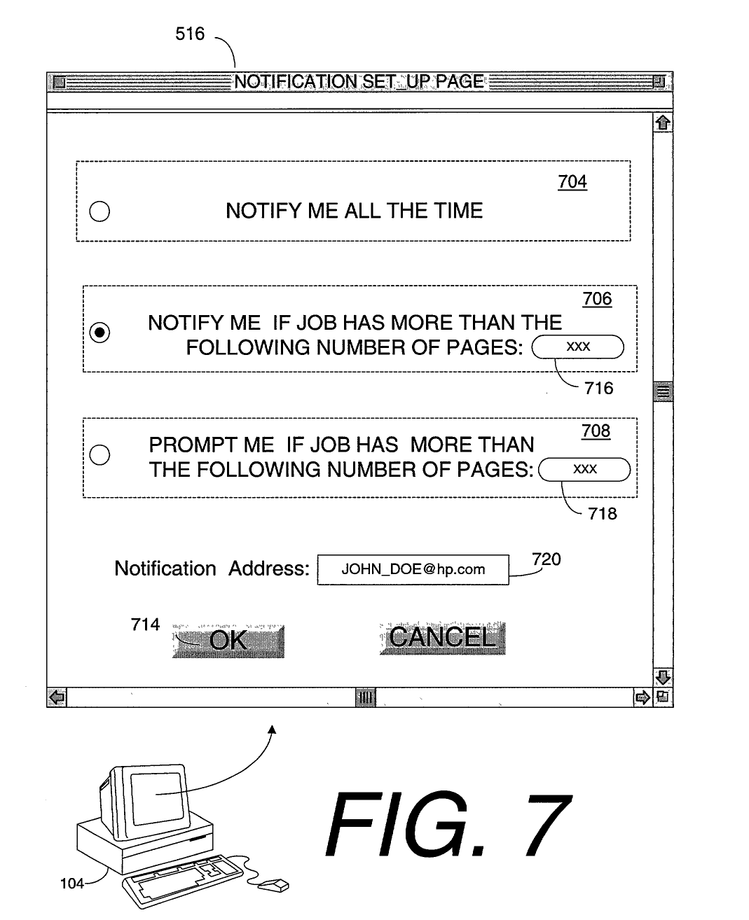

FIG. 7 illustrates the Web Page 516 in the present embodiment. Turning briefly to FIG. 7, the Web Page 516 provides, in this embodiment, three selectable notification options. These options are designated as follows: a first notification option 704, a second notification option 706 and a third notification option 708. The user can select any one of these three options.

The following provides an explanation of each of the three notification options.

### First Notification Option 704

The user can select the first notification option 704 if he/she prefers that the notification function of the printer is enabled for every print job the user submits.

### Second Notification Option 706

The user can select the second notification option 706 if he/she prefers that the notification function is enabled only for those print jobs that the user submits that meet a criterion. A print job meets the criterion if the job directs the printer to print at least a threshold number of pages. The user can specify the threshold number by entering a value in the first input field 716.

### Third Notification Option 708

The user can select the third notification option 708 if he/she prefers that the notification function is enabled for a job the user submits only if the following conditions exist:

(a) The print job directs the printer to print at least a threshold number of pages; and

(b) the user specifically requests that the notification function is enabled for the job.

The user can specify the threshold number of pages for this option by entering a value in the second input field 718.

### Notification Message Address

The Web Page 516 also includes a third input field 720. The user can specify the address (notification address) of the notification message by inputting an e-mail address in this field.

Referring again to FIG. 6B, the user interacts with the Web Page 516 so as to specify his/her notification preferences. This step involves the user selecting one of the three notification options and the user inputting his/her preferred notification address in the third input field 720.

The Web Browser 124 receives the user input at step 622. The Web Browser 124 then transmits the user's notification preferences (as specified by the user input) to the Printer 106 (step 624).

The Printer 106 receives the user's notification preferences at step 626. In response, the Printer 106 stores the user's notification preferences in the look-up table 518 so as to link the user's preferences to the user's PS ID (step 628).

The Printer 106 then proceeds to generate Web content based upon the user's notification preferences (step 630). The Printer 106 transmits the Web content to the Web Browser 124 (step 632). The Web Browser 124 receives (step 634) and executes the Web Content (step 636).

It is noted that the next time the user requests access to the printing service, a request for the service and the cookie is transmitted to the Printer 106. As noted above, the cookie specifies the user's PS ID. The Printer 106 can then make use of the cookie to identify the user's notification preferences that were stored in the look-up table 518. The printer 106 then proceeds to generate Web content based upon these preferences and to transmit this Web content to the Web Browser 124. Thus, the user does not have to re-enter his/her notification preferences each time the user makes use of the printing service.

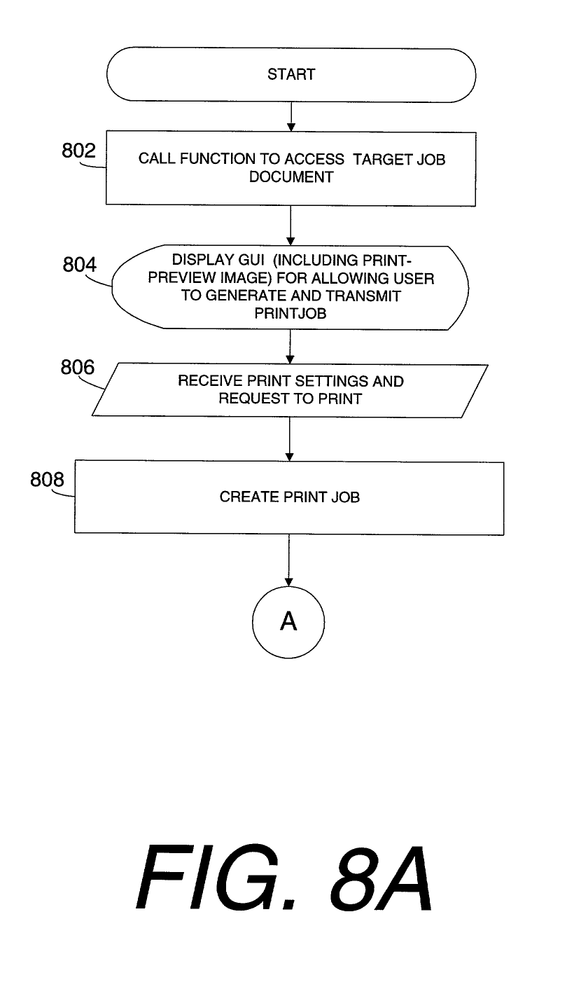

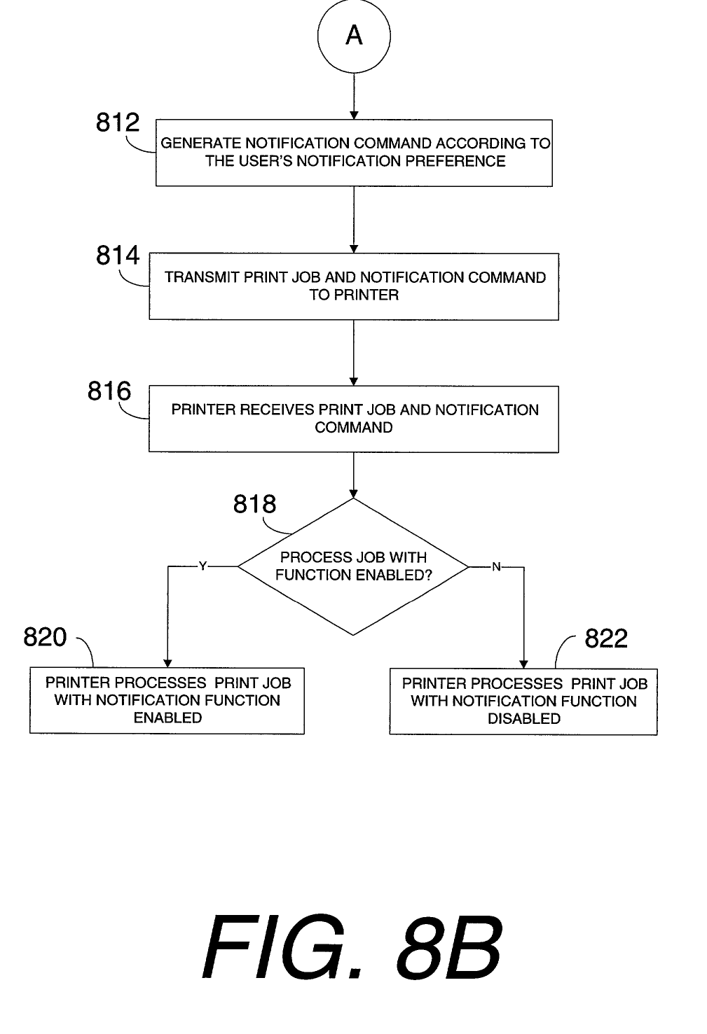

FIG. 8A and FIG. 8B is a flow chart that illustrates the operation of the Web content at step 636. Turning now to FIG. 8A, the Web content accesses the active user's personal job document (i.e., the target job document) by calling the PI function 126 (step 802).

Next, the Web content operates to display a graphical user interface (content GUI) that allows the user to select various printing options that are offered by the printer 106 (step 804). Additionally, the content GUI may also include a print-preview image of the target job document. The print-preview image may be based upon the imaging information received at step 802.

The active user can interact with the content GUI in order to select his/her desired print settings and to request that the target job document be printed. The Web content receives this user input at step 806.

In response to the user input, the Web content creates a print job (step 808). The print job is suitable to print the user's personal job document (i.e., the target job document) according to the print settings received from the user at step 806. The Web content may obtain the imaging information to generate the print job by again calling the PI function 126.

At step 812, the Web content generates a “notification command” in accordance with the user's notification preferences. The notification command indicates whether or not the notification function of the printer 106 should be enabled for the present job. The Web content then transmits the print job and the notification command to the printer 106 (step 814).

The printer 106 receives the print job and the associated notification command at step 816. If the notification command indicates that the notification function is to be enabled (decision step 818), the printer 106 proceeds to process the print job with the notification function enabled (step 820). If, however, the notification command indicates that the notification function should be disabled, the printer 106 proceeds to process the print job with the notification function disabled (step 822).

The following describes how the Web content may operate to generate the notification command under three different assumptions.

### Assumption #1: First Notification Option 704 Selected

If the active user had selected the first notification option 704, the Web content performs step 812 by generating a notification command that indicates the notification function should be enabled.

### Assumption #2: Second Notification Option 706 Selected

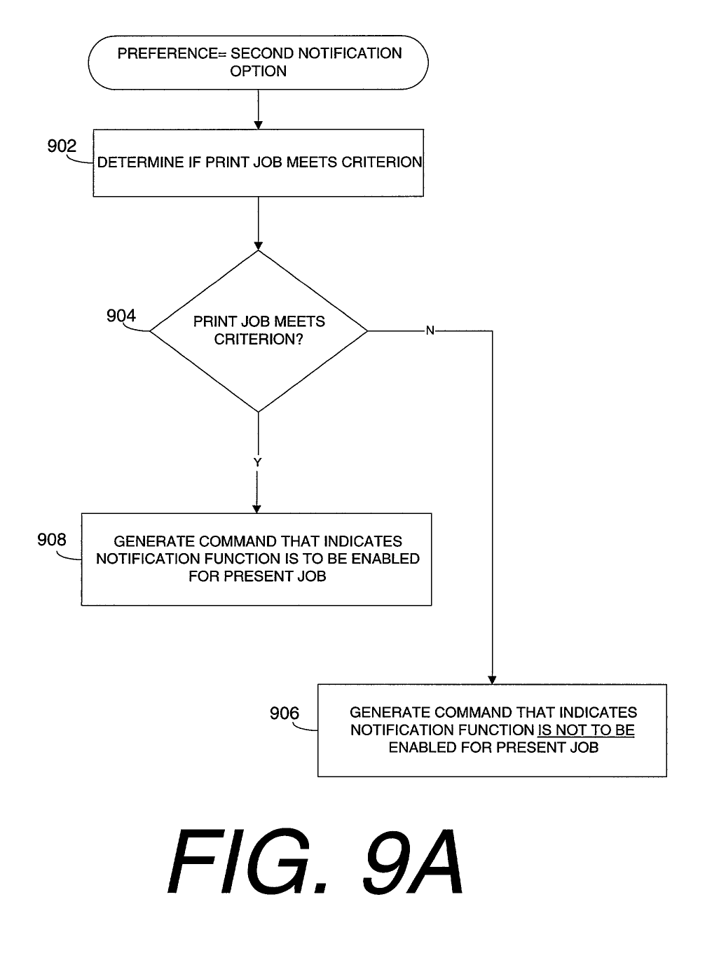

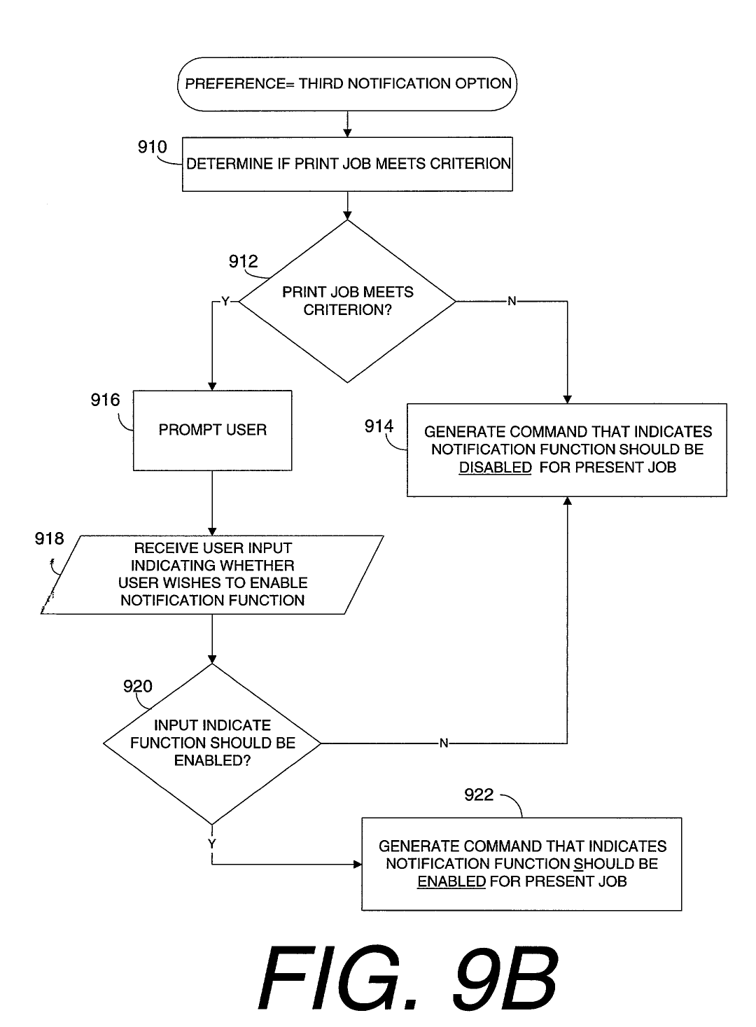

If the active user had selected the second notification option 706, the Web content performs step 812 according to the logic illustrated in FIG. 9A.

Turning briefly to FIG. 9A, the Web content operates to determine if the print job meets the criterion specified by the user (step 902). That is to say, the Web content operates to determine if the print job directs the printer to print more than the threshold number of pages specified by the user at step 622.

It is noted that step 902 may involve calling the PI function 126 in order to access the target job document. This may be done in order to determine the number of pages that make up the target job document. Step 902 may also involve determining the number of copies of the target job document that are to be printed.

If the print job does not meet the criterion (step 904), the Web content proceeds to perform step 812 by generating a notification command that indicates that the notification function should be disabled (Step 906). If, however, the print job does meet the user specified criterion, the Web Content performs step 812 by generating a notification command that indicates the notification function should be enabled (step 908).

To illustrate further, assume further that the following conditions exist:

(a) the user has specified a threshold page number of one hundred pages;

(b) the target job document is a ten page document; and

(c) the user has requested eleven copies of the target job document to be printed.

Under these conditions, the print job directs the printer to print one hundred and ten pages (10 pages×11 copies). Thus, the print job meets the user specified criterion as the print job directs the printer 106 to print more than 100 pages.

Therefore, in this example, the Web content would generate a notification command that indicates the notification function should be enabled for the present job.

### Assumption #3: Third Notification Option 708 Selected

If the active user had selected the third notification option 708, the Web content performs step 812 in a similar manner according to the logic illustrated in FIG. 9B.

Turning briefly to FIG. 9B, the Web content operates to first determine if the print job meets the criterion specified by the user (step 910). That is to say, the Web content operates to determine if the print job directs the printer to print more than the threshold number of pages specified by the user at step 622.

If the print job does not meet the criterion (step 912), the Web content proceeds to generate a notification command that indicates the notification function should be disabled (Step 914).

If, however, the document does meet the user specified criterion, the Web Content proceeds to prompt the user for input that specifies whether or not he/she wants the notification function to be enabled for the present job (step 916). The Web content receives this user input at step 918.

If the input received from the user indicates that the notification function should be disabled for the present job (step 920), then the Web content proceeds to generate a notification command that indicates the notification function should be disabled (Step 914).

If, however, the user input indicates that the notification function should be enabled for the present job (step 920), then the Web content proceeds to generate a notification command that indicates the notification should be enabled (step 922).

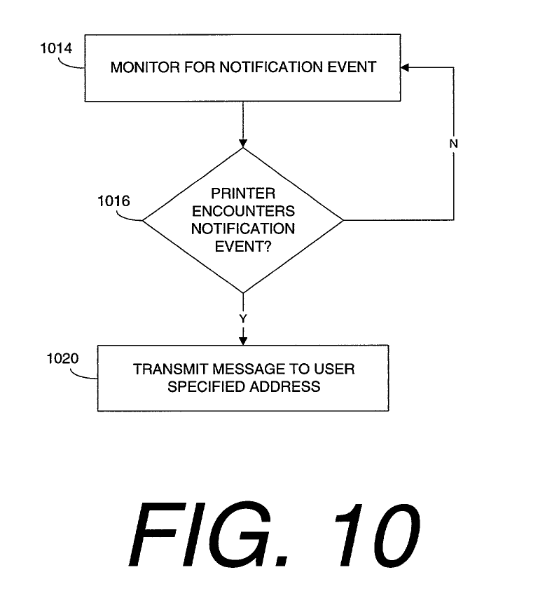

FIG. 10 is a flow chart illustrating the operation of the printer 106 to perform the notification function while processing the print job at step 820 (i.e., while processing the job with the notification function enabled). Turning now to FIG. 10, the printer 106 operates to monitor itself while processing the print job in order to detect the occurrence of a “notification event” (step 1014).

If a notification event is detected (decision step 1016), the printer 106 operates to transmit an e-mail message to the notification address that was specified by the user (step 1020). The message indicates that the notification event has occurred. In some implementations, if the notification event is an error condition, the message may provide helpful information to assist the user in resolving the condition. For example, the message may include a link to a Web page that provides the user with helpful information.

It is noted that any type of event may qualify as a “notification event”. For example, in the present embodiment a “job failure” qualifies as a notification event. As noted above, a job failure occurs when the printer 106 is unable to print at least a portion of the present job. Other events may also qualify. For example, any type of error or alert condition may qualify. Also, the successful completion of the present job may also qualify as a “notification event”.

From the forgoing example embodiment, it can be seen that the present invention provides a new and novel way to provide the user with information regarding the status of his/her job. Because the user can specify the address of the notification message, the message can “follow” the user. For example, the user may specify an e-mail address of his/her personal mail box that can be accessed from the comfort of the user's home. Also, the user may take advantage of various capabilities of an e-mail system. For example, the user may set-up his/her mail box so that when a notification e-mail is received, the user's personal pager or cell-phone beeps (i.e. the user may choose an e-mail address corresponding to the user's personal pager or cell-phone).

Additionally, and as just demonstrated in the foregoing embodiment, the user can enable the notification function based upon whether the user's job meets one or more criteria. This feature provides the user with an added dimension of control and can be used to accommodate the user's personal preferences. A user, for example, may wish to be notified only for jobs that print a large number of pages.

In alternative embodiments, the user is able to specify different e-mail addresses for different types of notification events. For example, the user may wish for an e-mail to be transmitted to one address in the event the printer encounters a job failure and a second address if the printer successfully prints the job. Sending an e-mail to the first address may result, for example, in causing the user's beeper to beep.

In another set of alternative embodiments, the user is able to specify multiple addresses. When the printer encounters a notification event, the printer functions to transmit a message to each of these addresses. One of these addresses, for example, may specify the mail box of a system administrator, an associate of the user, etc.

In the foregoing discussion, it can be seen that the PI function 126 provides a client side mechanism that can provide a web based service access to the user's job document when the user is actively using the service. The user's job document is identified based upon his/her online identity that exists on the client side.

It should be understood, however, that other mechanisms (including server side or system wide mechanisms) may be used to provide this same or similar functionality. For example, a user's job document may be linked to his/her online identity that exists on a server or to an online identity that exists across a network system.

In some embodiments, for example, a remote server (document server) is provided that allows a user to establish a server side online identity, which may be defined by a user identifier (document server ID). The user can then remotely interact with the document server in order to designate a document to be his/her personal job document.

In these embodiments, a Web server (service provider) that provides a service can be configured to contact the document server in order to access the user's job document when the user is actively making use of the service. In order to enable this access, the user provides his/her document server ID to the service provider. The service provider can then make use of this information to interact with the document server in order to access the user's personal job document.

In this manner, therefore, the Service provider is able to access the user's pre-selected job document and use that document to synthesize Web content (that allows a user to establish notification preferences and to otherwise direct the printing of the user's personal job document). The Web content is then transmitted to the client.

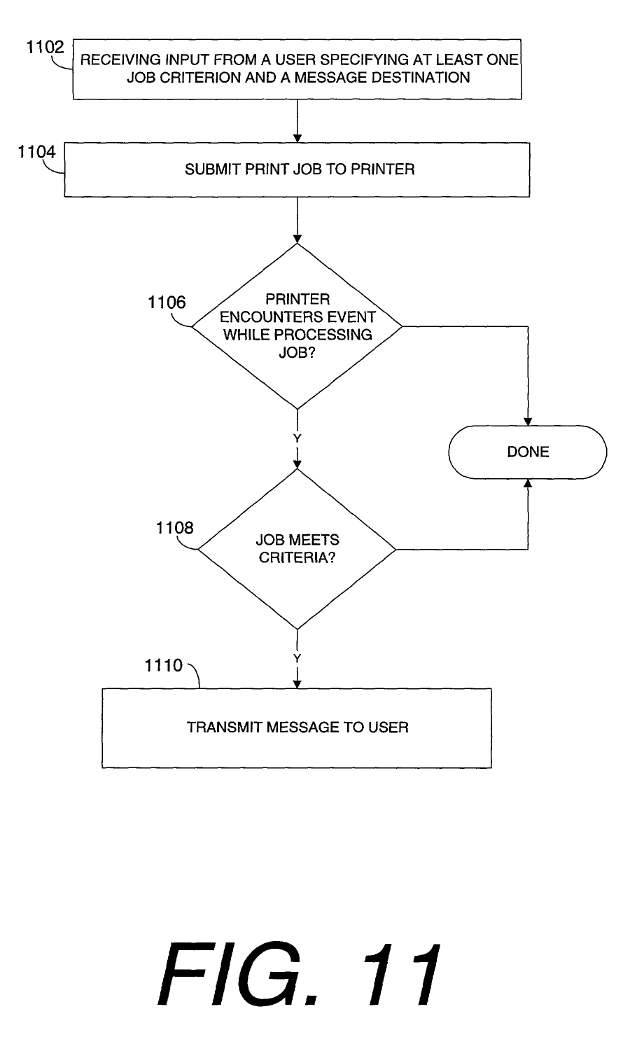

FIG. 11 is a flow chart illustrating yet another embodiment of the invention in the form of a method of transmitting a message. The method may be implemented, for example, in a computing system that includes a computer (e.g., a personal computer, workstation, personal digital assistant, etc) connected to a printer over a communication link.

Turning now to FIG. 11, input is received from a user that specifies at least one print job criterion and a message destination (step 1102). Next, the user submits a print job to the printer for processing (step 1104).

If the printer encounters a notification event while the printer is processing the print job and the print job meets the criteria (or criterion) specified by the user at step 1102, a message is transmitted to the user specified address (steps, 1106, 1108, 1110). The message preferably includes information associated with the event that was encountered.

It is noted that any computing device in the computing system may perform some or all of the steps depicted in FIG. 11. This includes the computer, the printer or some other device in the system. Also, the predetermined criterion may be any criterion that can be specified for the job. For example, the criterion may be associated with a document characteristic (e.g. number of pages, page size, font size, etc). The criterion may also be associated with a particular print setting. For example, a user may specify that the document meets the criterion only if it directs the printer to print in color mode.

It is important to also note that the present invention may be embodied in the form of a “computer readable medium”. For example, a memory that stores (either temporarily or permanently) the Web content described above may be considered an embodiment of the invention. It is also noted that the phrase “computer readable medium” can refer to any medium that can contain, store or propagate computer readable instructions. Thus, in this context, the phrase “computer readable medium” may refer to a medium such as a CD ROM or to signals that are used to communicate the computer readable code over a network, such as the Public Internet. The phrase “computer readable medium” may also refer to a carrier wave.

Although several specific embodiments of the invention have been described and illustrated, the invention is not to be limited to specific forms or arrangements of parts so described and illustrated. For example, the printer Web server described above may be provided by a remote server that is not embedded in the printer. Also, the Personal computer may alternatively represent a personal digital assistant (PDA). The invention is limited only by the claims and the equivalents thereof.

What is claimed is:

1. A method of transmitting a message, the method comprising:
transmitting a message to a remote destination when each of a set of pre-determined conditions exist, the pre-determined conditions include:
a device encounters an event while processing a job; and
the job meets a pre-determined criterion.

2. The method of claim 1, wherein the device is a printer and the job is a print job.

3. The method of claim 2, wherein the event is a job failure.

4. The method of claim 2, wherein the event is a successful completion of the print job.

5. The method of claim 2, wherein the job meets the predetermined criterion if it directs the printer to print at least a threshold number of pages.

6. The method of claim 2, wherein the message indicates that the event has occurred.

7. The method of claim 2, furthering comprising:
receiving input from a user that specifies the print job criterion and the location of the remote destination; and
in response to a request received from the user, submitting the print job to the printer.

8. The method of claim 7, wherein the message is an e-mail message.

9. The method of claim 7, wherein sending the message to the remote destination results in the user being paged.

10. A method of transmitting a message, comprising:
(a) receiving input that specifies at least one print job criterion and an e-mail address;
(b) submitting a print job to a printer for processing;
(c) if the print job meets the at least one print job criterion and the printer encounters an event while processing the print job, then transmitting an e-mail message to the e-mail address.

11. The method of claim 10, wherein the message indicates that the printer has encountered the event.

12. The method of claim 10, wherein the message includes a selectable hyperlink to a Web page that provides information regarding the event.

13. The method of claim 10, wherein the event is a job failure.

14. The method of claim 10, wherein the event is a successful completion of the job.

15. A computer readable medium embodying a program of instructions for causing a computer to perform method steps, the method steps comprising:
(a) receiving a request from a user to print a document:
(b) in response to the request, performing the following substeps:
(i) accessing the document to determine if the document has at least one characteristic;
(ii) submitting a print job that describes the document to a printer; and
(iii) if the print document has the at least one characteristic, commanding a device to transmit a message to a pre-determined address if the printer encounters an event while processing the print job.

16. The computer readable medium of claim 14, wherein the message is an e-mail message and the pre-determined address is an e-mail address.

17. The computer readable of claim 14, wherein the device is the printer.

18. The computer readable medium of claim 14, wherein the program of instructions comprises Web content.

19. A computing system, comprising:
(a) means for receiving input from a user that specifies at least one print job criterion;
(b) means for receiving a request from the user to submit a print job to a printer;
(c) means for responding to the request by submitting the print job to the printer; and
(d) means for transmitting a message to an address if the print job meets the at least one criterion and the printer encounters an event while processing the print job.

20. The computing system of claim 19, further comprising:
(d) means for receiving input from the user that specifies the address.

21. The computing system of claim 20, wherein the event is a job failure.

22. The computing system of claim 21, wherein the address is an e-mail address and the message is an e-mail message.

23. The computer system of claim 19, wherein the event is a paper jam condition.

24. The computer system of claim 19, wherein the computer system includes a computer connected to a printer over a network.
